(19) United States
(12) Patent Application Publication
(10) Pub. No.: US 2013/0246302 A1
(43) Pub. Date: Sep. 19, 2013

(54) SYSTEMS AND METHODS FOR PROVIDING AND OBTAINING VALIDATED CUSTOMER FEEDBACK INFORMATION

(71) Applicant: Terrillion, Inc., Alpine, UT (US)

(72) Inventor: Jonathan K. Black, Alpine, UT (US)

(73) Assignee: TERILLION, INC., Alpine, UT (US)

(21) Appl. No.: 13/841,886

(22) Filed: Mar. 15, 2013

Related U.S. Application Data
(63) Continuation-in-part of application No. 12/719,705, filed on Mar. 8, 2010, now Pat. No. 8,473,304.

(51) Int. Cl. G06Q 30/02

(52) U.S. Cl. CPC G06Q 30/0282
USPC 705/347

(57) ABSTRACT

Systems and methods for obtaining and providing validated customer feedback information about a ratable subject, such as a service, product, facility, etc. Generally, the methods include instructing a customer to provide initial customer feedback information about the ratable subject. The methods can further include using a digital ratings device to collect the initial customer feedback information and to associate that information with temporal data (such as time, date, location, or a unique QR code). The digital ratings device can also be used to send the initial customer feedback information and temporal data to a third-party validator. The validator can then validate the initial customer feedback information by checking the temporal data to ensure the customer is a verified customer of the ratable subject. The validated information may present a substantially fair representation of the ratable subject and can be useful to potential customers. Other implementations are also described.

### CROSS-REFERENCE TO RELATED APPLICATION

This application is a continuation-in-part of, and claims priority to, U.S. patent application Ser. No. 12/719,705, entitled “Systems and Methods for Obtaining and Providing Validated Customer Feedback Information,” filed Mar. 8, 2010; the entire disclosure of which is hereby incorporated by reference.

### FIELD OF THE INVENTION

The present invention relates in general to systems and methods for obtaining and providing customer feedback about a ratable subject matter. More particularly, the present invention provides systems and methods for providing validated customer feedback information about the ratable subject matter through the use of a digital ratings device that collects survey data, rating data, and other customer feedback information from a customer. In some cases, the digital ratings device also associates the customer feedback information with temporal data (such as the time, date, and location at which the customer provides the customer feedback information). In such cases, a third-party validator can validate the customer feedback information by checking the temporal data to ensure the customer is a verified customer of the ratable subject matter.

### BACKGROUND OF THE INVENTION

As customers search for a service provider or product, they often look in the phonebook, ask friends or relatives for recommendations, or otherwise try to research which service provider or product can best meet their specific needs and desires. One popular method for searching for and researching service providers and products involves searching the Internet for a list of service providers or products and looking for comments, ratings, reviews, or other information that some customers provide regarding their experience with, and their perception of, certain service providers or products.

While Web sites that provide rating and survey information about service providers or products obtain their information in a variety of manners, many such Web sites simply allow people visiting the sites to rate and provide comments or reviews about a particular provider or product.

While some conventional systems and methods for providing rating and survey information on the Internet may be somewhat useful to potential customers who are researching service providers or products, such methods and techniques are not necessarily without their shortcomings. In one example, people who are happy with a particular service provider or product typically have little to no incentive to post a positive review of such a provider or product. In contrast, people who are upset with a provider or product are often motivated to post a negative review of that provider or product as a way to hurt the success of, or otherwise express their dissatisfaction with, that particular provider or product. As a result, certain ratings/survey Web sites tend to provide an overall review of a service provider or product that is biased by one or more people who are not necessarily representative of the provider's or product's customer pool as a whole.

In another example, certain Web sites that provide rating/survey information about service providers or products may allow practically anyone who accesses such Web sites to post an anonymous review. As a result, such Web sites often do not and cannot ensure that the people posting reviews are, have recently been, or have ever been customers of the service provider's services. For instance, some Web sites allow competitors, enemies, and others who want to damage a service provider's or a product's reputation and success to pose as customers and to post fraudulent reviews about the provider or product. Additionally, because some Web sites allow reviews to be posted anonymously, some people feel no accountability for their actions and go overboard in writing positive or negative reviews about a particular service provider or product.

In still another example, some Web sites that provide rating/survey information about service providers or products allow those posting comments to post more than one review about a particular service provider or product. Consequently, such Web sites can allow people to skew the overall rating/survey information in a manner that unduly harms or benefits particular service providers or products.

As a result of one or more of the aforementioned shortcomings, some companies (i.e., some service providers) have become so worried that the information provided through online ratings/survey Web sites is biased, that such companies have had their customers sign gag agreements (or agreements in which the customers agree not to post any form of a review about the provider or a particular product on the Internet).

In short, some Web sites that provide ratings/survey information about service providers or products end up giving an unfair representation of certain providers or products. Similarly, where the information provided on such Web sites is skewed, fraudulent, extreme, or otherwise inaccurately represents the feelings of the provider's or product's actual customers as a whole, the value of such information to potential customers is diminished.

Moreover, because certain Web sites are more likely to receive negative reviews of a service provider or product than they are likely to receive positive reviews, such Web sites tend to contain relatively large amounts of content relating to service providers or products who are generally considered as being substandard. At the same time, because such Web sites tend to receive or produce relatively few positive reviews, such Web sites tend to have a relatively small amount of content that relates to service providers or products that would generally be considered as being above-standard. Because certain search engines rank Web sites by the amount of content the Web sites have relating to a particular service provider or product, the Web sites described above can bury excellent service providers and products in the search engine results, while bringing substandard service providers and products to the top of the search results. In other words, certain ratings Web sites can actually promote substandard service providers and products while making it harder for Internet users to find information about excellent service providers and products.

Thus, while techniques currently exist that are used to provide rating/survey information about service providers and products, challenges still exist, including challenges that diminish the overall fairness of particular ratings systems to certain service providers and products, as well as to the overall usefulness of the rating/survey information provided to potential customers. Accordingly, it would be an improvement in the art to augment or even replace current techniques with other techniques that are intended to provide fair and reliable reviews of service providers or products.

### BRIEF SUMMARY OF THE INVENTION

The present invention provides systems and methods for obtaining and providing validated customer feedback information about a ratable subject matter, such as a service provider, a service, a product, a facility, etc. Generally, the methods include instructing (or otherwise inviting) a customer at a point of service/sale to provide initial customer feedback information about the ratable subject matter. The methods can further include using a digital ratings device (such as a digital pen, smart phone, tablet computer, personal digital assistant (“PDA”), etc.) to collect the initial customer feedback information and to associate that information with temporal data (such as time, date, location, a unique quick response code, etc.). While the initial customer feedback information can be obtained in any suitable format (e.g., as text, in digital writing, etc.), in some implementations, this information is obtained as digital handwriting (e.g., via a finger/stylus on a touch screen, etc.), computerized text, symbols, colors, etc.

The digital ratings device can also be used to send the initial customer feedback information and temporal data to a third-party validator. In turn, the validator can validate the initial customer feedback information by checking the temporal data to ensure the customer is a verified customer of the ratable subject matter. Because the information is validated as coming from a verified customer, the information can be relatively reliable. Thus, the validated information may present a substantially fair and reliable representation of the ratable subject matter and can be useful to potential customers. While the validated information can be displayed in any suitable manner, in some implementations, it is displayed as handwriting (e.g., as a digital image containing handwriting).

In some implementations, the described systems and methods also provide a reliability index for validated information. While this can be done in any suitable manner, in some cases, each time a customer provides initial customer feedback information, the described systems and methods search for a variety of different types of temporal data and/or other information (such as, but not limited to, a time stamp, a date stamp, a location stamp, a digital device ID, a computer ID match, a survey ID match, a provider ID match, a business ID match, a handwriting analysis, human verification data, a business hours match, a consumer name, pre-screen research on the customer, a social media based customer ID, an e-mail ID verification, acknowledgement from the customer that he or she is an actual customer of the ratable subject matter, information as to whether the customer agreed to a terms of use agreement, and/or a variety of other information that tends to show that the customer is an actual customer of the ratable subject matter). When the systems are able to verify a relatively high (or preselected) number of pieces of the temporal data for particular initial customer feedback information, the systems are able to provide a relatively high reliability index for the corresponding validated information.

In some instances, the described systems and methods optionally include a sponsorship feature. In such instances, a sponsor can donate money to a charity as customers provide initial customer feedback information or as the described systems and methods are otherwise used. In this manner, customers may be incentivized to provide a review of the ratable subject, without the customers receiving a direct benefit for doing so. Because customers may not be receiving a direct benefit for providing a review, such customers may be more likely to provide an honest review of the ratable subject matter, than they otherwise would if they were receiving a direct benefit for providing their review.

While the described systems and methods may be particularly useful for providing validated customer feedback information for healthcare providers (including, without limitation, doctors, hospitals, nurses, clinics, physicians' assistants, dentists, pharmacists, home healthcare providers, and the like), the skilled artisan will recognize that the described systems and methods may be used to provide validated customer feedback information for virtually any person, entity, organization, product, service, facility, or virtually any other subject matter that can be rated. For example, instead of being limited to healthcare providers, the described systems and methods can be used for restaurants, hotels, repair shops, hospitality services, assisted living centers, merchandise dealers, retail stores, merchandise, products, facilities, individuals (e.g., lawyers, accountants, mechanics, etc.), materials, or any other person, product, entity, or item that can be rated and reported about on the Internet.

These features and advantages of the present invention will become more fully apparent from the following description and appended claims, or may be learned by the practice of the invention as set forth hereinafter.

### BRIEF DESCRIPTION OF THE SEVERAL DRAWINGS

In order that the manner in which the above-recited and other features and advantages are obtained and will be readily understood, a more particular description of the embodiments of the invention briefly described above will be rendered by reference to specific embodiments thereof that are illustrated in the appended drawings. Understanding that the drawings depict only typical embodiments of the invention and are not therefore to be considered to be limiting of its scope, the invention will be described and explained with additional specificity and detail through the use of the accompanying drawings in which:

FIG. 1 illustrates a flow chart depicting a representative embodiment of a method used by an interested party to obtain validated customer feedback information about a ratable subject matter;

FIG. 2 illustrates a flow chart depicting a representative embodiment of a method used by a third-party validator to provide the validated customer feedback information;

FIG. 3 illustrates a flow chart depicting a representative embodiment of a method for obtaining and providing the validated customer feedback information;

FIG. 4 illustrates a representative system that provides a suitable environment for some embodiments of the described systems and methods; and

FIG. 5 illustrates a representative networked system that provides a suitable environment for some embodiments of the described systems and methods.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of suitable ratable subject matter, digital ratings devices, validation techniques, temporal data, subject matter data, etc., to provide a thorough understanding of embodiments of the invention. One having ordinary skill in the relevant art will recognize, however, that the invention may be practiced without one or more of the specific details, or with other methods, components, materials, and so forth. In other instances, well-known structures, materials, methods, or operations are not shown or described in detail to avoid obscuring aspects of the invention.

The present invention provides systems and methods for providing validated customer feedback information (also referred to herein as “validated information”) about a ratable subject matter. Accordingly, the described systems and methods may provide fair and reliable feedback information about a ratable subject matter. Generally, the described systems and methods involve allowing a customer to provide initial customer feedback information (also referred to herein as “initial information”) about a ratable subject matter and then checking to ensure that the initial information was provided by a verified customer, or by a person who has been shown to be an actual customer of the ratable subject matter. By identifying initial information as coming from a verified customer, the described systems and methods can designate the initial information as being validated information.

The described systems and methods can be used to obtain and provide verified information relating to virtually any subject matter that can be rated (also referred to herein as “ratable subject matter” or “ratable subject”). In this regard, some examples of suitable ratable subject matter include, but are not limited to, one or more service providers, services, individuals, Web sites, products, facilities, materials, advertisements, packages, and/or other people, individuals, groups, entities, and/or matter that can be rated and/or for which verified information can be posted on the Internet.

The described methods can also be accomplished by any suitable type or number of actors. In some embodiments, however, the described methods are accomplished by one or more interested parties, customers, service providers, and third-party validators. In such embodiments, an interested party can comprise any person, group, or entity that it is interested in obtaining and/or publishing verified information about a ratable subject matter. Some examples of interested parties include, but are not limited to, one or more service providers, product manufacturers, providers of consumer reports, market-research firms, public-opinion firms, third parties, third-party validators, authors, magazines, books, individuals, and/or other people, groups, or entities (i.e., their employees, agents, representatives, or anyone working on their behalf) that are interested in generating verified information about a ratable subject matter. Indeed, while in some embodiments, the interested party comprises a service provider (e.g., a dentist, doctor, lawyer, etc.), in other non-limiting embodiments, the interested party comprises both a service provider and a market-research firm that has agreed to collect initial customer feedback information for the service provider.

As used herein, the term customer may refer to virtually any suitable person who is able to provide initial customer feedback information regarding a ratable subject matter. Some non-limiting examples of suitable customers include one or more clients, consumers, patrons, patients, people who pay to receive a service, people who pay to receive a product, and any other suitable person who receives (or who even attempts to receive, researches, contemplates receiving, or is exposed to) a particular ratable subject.

The term service provider may be used herein to refer to any suitable person, group, entity, organization, etc. that provides a service or a product to a customer. In some embodiments, however, the described methods are used to provide validated information about healthcare services providers, legal service providers, retail outlets, product providers, home services, services, food providers, advertising providers, guest service providers, merchandise providers, etc.

As used herein, the term third-party validator may refer to any suitable person, group, entity, software, device, and/or other actor that determines whether initial information regarding a particular ratable subject matter was given by a verified customer of that ratable subject. In one non-limiting embodiment, the third-party validator comprises software, such as a Web-based, cloud-based, platform as a service, and/or a client-based software application, which validates whether the initial information was provided by a verified customer. In another non-limiting embodiment, the validator comprises one or more individuals (e.g., a third party) who checks a customer's initial information to validate that information. In still another non-limiting embodiment, the validator comprises a software application and one or more individuals that are capable of validating the customer's initial information.

As used herein, the term handwriting may refer to any form of human, manually-generated writing, text, symbols, or other feedback (as opposed to computerized characters that are generated by activating keys on a keyboard, computer device, etc.). In this regard, handwriting may be provided in any suitable manner, including, without limitation, through the use of a digital pen, a touchscreen device, a camera that captures images of handwriting, a signature/writing capture device, and/or any other suitable device. Additionally, handwriting can be obtained and used in any suitable format, including, without limitation, as one or more images of handwriting, as digital information describing the handwriting, etc.).

The described methods can be accomplished in any suitable manner that allows the third-party validator to validate a customer's initial information as originating from a verified customer. To provide a better understanding of the described methods, several embodiments of suitable methods and systems are described below in more detail. Specifically, the following discussion first provides a detailed description of a non-limiting embodiment of a method that an interested party can follow to obtain validated customer feedback information. Following this discussion, a detailed description is provided of a non-limiting embodiment of a method that a third-party validator can follow to provide validated information about a ratable subject matter. It should be noted, that each of these methods can be modified in any suitable manner. For instance, any suitable step can be added to, be removed from, be modified, and be reordered within each of the methods. It should also be noted, that while the term step is used herein, that term may be used to simply draw attention to different portions of the described methods and is not meant to delineate a starting point or a stopping point for any portion of the methods, or to be limiting in any other way.

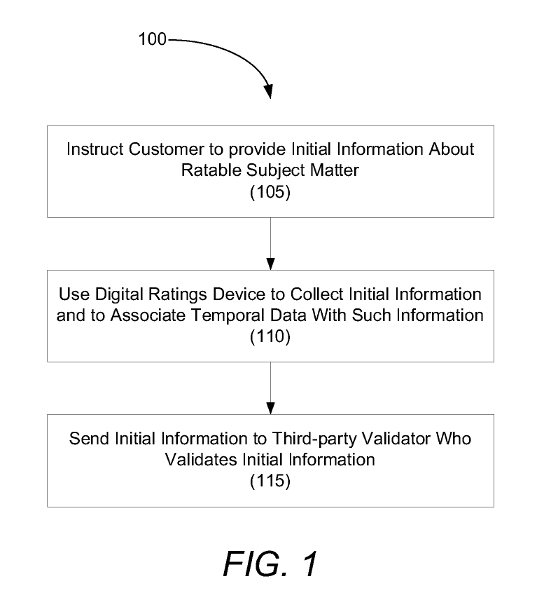

As previously mentioned, FIG. 1 illustrates a non-limiting embodiment of a method 100 for obtaining validated information through actions performed by an interested party (e.g., a service provider that desires to have its reputation accurately and fairly represented online). In particular, FIG. 1 shows the method 100 begins at step 105 where the interested party invites or otherwise instructs the customer to provide initial information about a ratable subject matter (e.g., the service provider's services). As used herein, the terms instruct and invite may be used interchangeably and may include verbally asking the customer to provide initial information; providing signage, text, images, etc. (e.g., signage with a quick response code (“QR code”), a short code, a text number etc.) that allows or invites the customer to provide initial information; and/or any other method that presents the customer with the ability (or otherwise invites the customer) to provide initial information. Additionally, the terms initial information, initial customer feedback information, and variations thereof, may be used herein to refer to any suitable information that the customer (or another actor) can relay to the third-party validator through the use of a digital ratings device (discussed below). Non-limiting examples of suitable initial information include ratings related to: the ratable subject matter; survey and questionnaire responses; customer comments; reviews; and any other suitable information that can be provided to a third-party validator through the use of the digital ratings device.

While step 105 can be accomplished at any suitable time, in some embodiments, this step occurs shortly after the customer is exposed to (e.g., receives) the ratable subject matter. Indeed, in one non-limiting example, a member of an interested party's staff (e.g., a receptionist) instructs the customer to provide initial information after the customer has received or otherwise been exposed to a ratable subject (e.g., been seen by a doctor, purchased a product, etc.), but before the customer leaves the interested party's facility. In other embodiments, however, the interested party instructs the customer to provide initial information before receiving the ratable subject. By way of non-limiting example, the interested party can instruct the customer to provide initial information (e.g., regarding the condition of a facility, how the customer heard of a product or service, how hard it was to find the facility, etc.) before receiving a product or service. In still other embodiments, the interested party instructs the customer to provide the initial information as the customer receives the ratable subject matter (e.g., at the point of purchase). In still other embodiments, the customer is instructed without receiving any personal interaction with another person. By way of non-limiting example, signage or another display at a point of service, instructs the customer to provide initial information (e.g., by scanning a QR code, sending a text, etc.). Thus, in the previous examples, the interested party is able to instruct the customer (directly or indirectly) to provide the initial information at specific time and location (e.g., at the point of service or sale).

The interested party can use any suitable method to instruct one or more customers (including potential customers) to provide initial information about the ratable subject. In one example, at the point of service/sale, the interested party provides the customer with (or allows the customer to use) a digital ratings device (discussed below) and a survey/rating form (e.g., a survey, questionnaire, ratings sheet, fillable e-mail, a fillable text message, a text message requesting a response, Web site, paper, digital paper, and/or other form or media that allows the customer to provide initial information). In another example, the interested party verbally invites the customer to provide initial information. In still another example, the interested party provides a marking (e.g., QR code, bar code, uniform resource locator, text number, short code, text-in number, etc.) that is capable of directing the customer to a Web site (e.g., via the digital ratings device), text, or other location providing a survey/rating form. In this regard, the marking can be placed in any suitable location, including, without limitation, on or in posters, advertisements (e.g., tent advertisements), magazines, newspapers, brochures, books, billboards, business cards, television programming (e.g., commercials), movie screen content, Web sites, products, merchandise, signs, displays (e.g., point of purchase displays), and any other suitable locations. In still another example, the interested party provides or otherwise makes available a piece of application software (e.g., an “app”) that provides access to one or more survey/rating forms available. In yet another example, the interested party invites (e.g., via a marking, verbally, etc.) the customer to send a text message that will cause the digital ratings device (discussed below) to open or provide a link to a Web site or to receive an e-mail or a text message comprising a fillable survey/rating form.

At step 110, FIG. 1 further illustrates that the method 100 can continue as a digital ratings device is used to collect the initial information and to associate such information with temporal data. In this regard, the digital ratings device can comprise any suitable electronic device that is able to collect initial customer feedback information, to record temporal data (described hereinafter), to associate the initial information with its corresponding temporal data, and that can be used to transfer the initial information and the temporal data to a third-party validator. Some non-limiting examples of the digital ratings device include a known or novel: digital pen; touch screen device; PDA; laptop computer; tablet computer (e.g., an IPAD® tablet, ANDROID® tablet, etc.); hand-held computer, smart phone; cellular phone; feature phone; fax machine; camera; computer; signature/writing capture device; and/or any other electronic device or system (such as a docking system, a computer, a modem, a cellular telephone, Web site, etc.) that helps the digital ratings device collect initial information from the customer, associate the initial information with temporal data, and/or electronically transmit the initial information and the temporal data to the third-party validator.

At step 110, the initial information can be collected by the digital ratings device in any suitable manner. In one example, where the digital ratings device comprises a computer device that is capable of connecting to the Internet (e.g., a smart phone, tablet computer, PDA, etc.), the digital ratings device can collect the initial information (and temporal data, discussed below) in any suitable manner, including, without limitation, through the use of a Web site or a fillable e-mail or text message form.

Where the digital ratings device collects initial information through the use of a Web site or a fillable e-mail or text message form, the digital ratings device can access such a Web site or fillable form in any suitable manner. In some cases, the customer can input a URL that opens a Web site or a fillable e-mail form. In other cases, where the digital ratings device (e.g., a tablet computer, such as an IPAD® or ANDROID® device, a smart phone, a feature phone, etc.) comprises a camera, QR code reader, bar code reader, etc. (collectively, “camera”), the camera can be used to capture an image of a marking (e.g., a QR code, bar code, etc.) that directs the device to a Web site or fillable e-mail form presenting a survey/rating form. In such embodiments, the survey/rating form can be completed in any suitable manner, including, without limitation, through the use of a touch screen interface (e.g., with a finger, stylus, etc.), as handwriting, as computerized text generated through the use of a keyboard (e.g., a physical keyboard, a keyboard on a touch screen device, etc.), a voice recognition system, and/or any other suitable input mechanism and/or any other suitable manner.

In another example in which the digital ratings device comprises a personal computing device having a camera (including, without limitation, a still or video camera), the customer is able to provide the initial information (e.g., as handwriting, etc.) on paper or some other physical medium. Once the customer has provided the initial information, the user (e.g., the customer) can then use the digital ratings device to take a picture of the medium with the initial information. Thus, in this example, the customer can provide the initial information in a hand-written format, while being able to take the completed survey/rating form (e.g., paper) with the customer.

In another example in which the digital ratings device comprises a personal computing device having a video camera or an audio recorder, the customer is able to provide the initial information through a video and/or audio recording of the customer.

In still another example in which the digital ratings device comprises a point-of-sales transaction device, the digital ratings device can comprise any suitable component that allows the customer to input initial information. In some embodiments, the point-of sale transaction device comprises a credit card reader (e.g., a swipe reader, a near-field credit-card reader, etc.) and one or more input mechanisms through which the customer can provide initial information. Some non-limiting examples of such input mechanisms include a signature/writing capture device, a touch screen, a pin pad, a camera, a scanner, and a stylus. Accordingly, as or after the customer pays for a product or service, the customer can quickly provide initial information.

In yet another example in which the digital ratings device comprises a conventional digital pen, the digital pen may comprise any suitable component or characteristic that allows it to function as the digital ratings device. In one non-limiting example, the pen comprises ink that allows the customer to see information (e.g., handwriting) as it is written. In another non-limiting example, the digital pen comprises a mechanism for recording initial information and uploading that information (e.g., as handwriting, an image of handwriting, handwriting converted to computerized textual characters (e.g., via a handwriting recognition mechanism), and/or any other suitable format) to the third-party validator. In this example, the mechanism or mechanisms for recording and then transmitting initial information to the validator, may comprise any suitable characteristic, including, but not limited to, a small camera or sensor that takes images of a pattern the camera sees as the pen writes (e.g., a unique digital pattern in the form's background) a memory component, and a communications device or port that allows the pen to upload its pictures to the third-party validator. Accordingly, after the customer uses the pen and form to provide initial information, the customer can take the form and leave the pen with the interested party.

In yet another example, where the digital ratings device comprises a fax machine and/or a camera, the customer can provide initial information on a physical medium, and can then have an image containing the initial information (e.g., as handwriting, symbols, and/or any other suitable format) be submitted to the third-party validator.

In still another example, where the digital ratings device comprises a device that is capable of sending a text message (e.g., a tablet device, a smart phone, a feature phone, etc.) or using a short message service, the customer is invited (e.g., via a making, such as a short code, on signage, a display, etc.) to send a text with a keyword/code. In such embodiments, the customer receives a response that allows the customer to provide initial data. Indeed, in some embodiments, the customer receives a text message response that includes a link to a survey/rating form, or a Web site having such a form. In other embodiments, however, the customer receives a text response that asks the customer to provide initial information by sending another text. By way of non-limiting illustration, after the customer sends a first text with a keyword/code, the customer receives a text stating “How do you rate Dr. Smith's bedside manner? (Reply to this text with your rating (1-5, where 5 is the best) and comments).”

In some instances, where the digital device accesses a Web site to allow the customer to provide initial information, the Web site is only accessible when the customer is at the point of purchase. While this can be done in any suitable manner, in some non-limiting embodiments, the Web site is only accessible when the customer scans a marking (e.g., a QR code, a bar code, etc.) at the point of purchase. In other embodiments, the Web site is only accessible when the described systems determine the customer is at the point of purchase (e.g., via checking the global positioning system (“GPS”) coordinates of the digital device, or otherwise determining that the customer is at the point of purchase). Accordingly, instead of being able to type in a uniform resource locator or URL into a Web browser so that the customer (or a non-customer) can provide initial data at any time or place, in some embodiments, the customer is only able to provide initial data at a certain location (e.g., the point of purchase/sale) and/or time (e.g., during business hours).

As shown above, in certain instances, the interested party is not necessarily present as the customer provides initial information. As a result, the interested party is not necessarily aware of which customer provided which initial information. Accordingly, in certain instances, the collection of initial information includes a “blind” collection method, which can foster honest opinions and reliable customer feedback.

As mentioned at step 110 of FIG. 1, in some embodiments, the digital ratings device associates temporal data with the initial information provided by each customer. In such embodiments, the temporal data can comprise any data that allows the third-party validator to identify the customer as being a verified customer of the ratable subject matter. Some examples of suitable temporal data include, but are not limited to: the time (e.g., a time stamp), date (e.g., a date stamp), and location (e.g., a location stamp) at which the customer provided the initial information (or at which the customer or interested party uploaded the information) through the use of the digital ratings device; a unique digital identifier of the digital ratings device (e.g., a globally unique identifier, a serial number, a universally unique identifier, a device ID, etc.); a unique digital pattern on a survey/rating form, as recorded by the digital ratings device; a survey identifier that has been assigned to or placed on a survey/rating form; an internet protocol (“IP”) address of the computer or electronic device that uploads the initial information; the GPS coordinates of the digital recordings device (which may include a mechanism that relays information from the digital ratings device to the third-party validator); an O-code generated for the digital device; the caller ID information from a telephone or fax machine that transmits initial information from the digital ratings device to the third-party validator; a central processing unit identification (“CPU ID”) from a computer that relays information from the ratings device to the validator; a computer ID; a facility identifier (e.g., a store identification number, address, etc.); a business ID; a provider ID; an identifier of a point-of-sale transaction device; a marking associated with a product (e.g., a QR code, a bar code, short code, etc.), service, survey/rating form, service provider, etc.; a human verification of a customer's submission (e.g., an indication that a person (e.g., the interested party) saw the customer provide initial information); a handwriting analysis for a customer's submission; a customer name; pre-screen research on the customer (e.g., research indicating that the customer had an appointment, or any other research that indicates that the provider of initial information is an actual customer of the ratable subject matter); the customer's social media identification (e.g., the customers FACEBOOK® username); the customer's e-mail identification (e.g., the customer's e-mail address and/or username); any other suitable information, and any combination of the foregoing that can be used to identify the customer as being a verified customer of the ratable subject matter. Indeed, in some non-limiting embodiments, the temporal data comprises the time, date, and location at which initial information is provided. Moreover, the temporal data can comprise any suitable number of factors including, without limitation 1, 2, 3, 4, 5, 6, 7, 8, or more. By way of non-limiting example, the temporal data can include 20 factors ±10.

In some embodiments, where the temporal data comprises a marking that is associated with a product, service, service provider, survey/rating form, or other ratable subject, the marking can comprise any suitable marking that allows the validator to validate the customer as an actual customer of the ratable subject matter. In one example, the marking comprises a QR code, a bar code, a text, a short code, a vanity code, etc. In another example, the marking comprises a unique mark (e.g., a QR code, bar code, etc.) that is associated with an individual item. In this example, each and every piece of inventory of a particular product can have a different marking. In this manner, the validator can ensure that only one batch or rating providing initial information is submitted for each individual piece of inventory. Accordingly, in this example, a customer can only give initial information one time for a marking or specific ratable subject. Additionally, because, in some embodiments, the marking is intended to only be used after the product or its packaging has been opened (e.g., the marking is inside of a product or package), the validator can ensure that the initial information associated with such a marking is provided by an actual customer of the ratable subject matter.

Where the digital ratings device associates temporal data with the customer's initial information, the temporal data can be collected and/or associated with the initial information at any suitable time. In one non-limiting example, the digital ratings device collects temporal data as the customer uses the device to input initial information. For instance, temporal data can be collected with each stroke of a digital pen, entry into a Web site, or other input into the digital ratings device to indicate the time and/or other circumstances at which the input occurred. In another non-limiting example, temporal data is collected after the customer provides initial customer feedback information. For instance, temporal data (e.g., an IP address of a computer sending the initial information, GPS coordinates of the device, etc.) can be collected when the initial information is sent to the third-party validator. In still another non-limiting example, temporal data, such as the digital ratings device's unique digital identifier, is collected before the customer provides the initial information and is then transmitted after the information is provided.

Returning to FIG. 1, that figure shows that after the customer has provided initial customer feedback information, the interested party, customer, or another actor can upload the initial information and the temporal data to the third-party validator (e.g., through the use of the digital ratings device). Indeed, in one example, after the customer provides the initial information, the customer submits such information (e.g., by selecting a “submit” feature, by completing the last question, etc.). Accordingly, in this example, the interested party has no control over which information is uploaded. Said differently, because the customer in this example uploads the initial information, the interested party is not able to prevent initial information that potentially reflects poorly on the ratable subject, or to allow only initial information that will potentially reflect well on the ratable subject to be uploaded. In any case, the validator can check the temporal data to ensure that the initial information was provided by a verified customer.

The initial information and temporal data can be uploaded, sent, or released to the third-party validator in any suitable manner. In one non-limiting example, the digital ratings device is wirelessly connected to a telephone or modem through a BLUETOOTH® or a WI-FI® connection. In this example, during or after the time in which the customer provides initial information, the telephone or modem uploads the initial information and temporal data to the third-party validator. In another example, the customer uploads the initial information directly to validator (e.g., via an Internet connection on the digital device). In another non-limiting example, the digital ratings device stores the initial information until the device is placed in a docking station. In this example, when the digital ratings device is docked, the initial information and the temporal data are sent (e.g., via a network) to the third-party validator. Thus, in this example, the digital ratings device can collect initial information from a plurality of customers before the device is docked and the initial information is transmitted to the validator. In another example, the customer can submit the initial information after providing it (e.g., by sending an image of the initial information to the validator, by completing a survey/rating form on a Web site or point-of-sale device, by responding to a text, by faxing the initial information to the validator, etc.). In still another non-limiting example, the interested party can upload initial information from one or more customers in any suitable manner, including, without limitation, by sending images containing the initial information to the validator. In yet another non-limiting example, the initial information gathered from a survey/rating form can be encoded or otherwise converted into a text message or an e-mail that is sent to the validator and that conveys the initial information in a manner that requires a relatively small amount of data usage.

The method 100 in FIG. 1 can be repeated for any suitable number of customers in a specified period of time. Accordingly, the described methods can be used to obtain initial information from practically any customer that is willing to provide initial customer feedback information. As a result, the described methods can help provide validated information from a group of the ratable subject's customers that is more representative of the subject's actual customers as a whole than is typically the case in certain online rating/survey Web sites that tend to reflect the opinions of a relatively small number of angry customers. Accordingly, the described systems and methods can provide a relatively fair representation of the ratable subject.

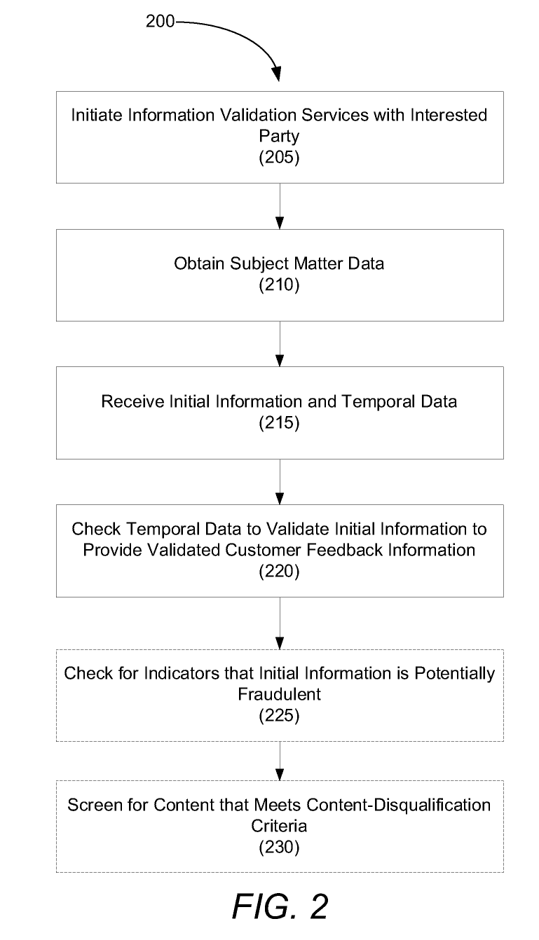

Moving on to FIG. 2, that figure illustrates a non-limiting embodiment of a method 200 that a third-party validator follows to provide validated information about the ratable subject matter. Specifically, FIG. 2 shows that this particular embodiment of the method 200 begins at step 205 as the third-party validator initiates its information validation services with one or more interested parties (e.g., service providers who want an accurate and fair depiction of their reputation placed online). In this step, the third-party validator can initiate its services with the interested party in any suitable manner, including, without limitation, by providing the interested party with one or more digital ratings devices, by providing the interested party with QR codes, (or other markings) (e.g., via signage, a display, etc.) that direct customers and/or certain digital ratings devices to a custom Web site containing a survey/rating form; by providing the interested party with text numbers, short codes, or other data that allows a customer to access a survey/rating form (e.g., via a textual link to a Web site, via a textual survey, etc.) after the customer sends a text; by providing the interested party with a relevant survey/rating form; by activating one or more digital ratings devices so that the devices are capable of transmitting initial information to the validator; by installing software for the digital ratings device on the provider's computers; by providing the interested party with a username and password; by having the interested party sign an agreement stating that it will only instruct or otherwise allow actual customers to provide initial data; and/or by otherwise making it possible for the interested party to obtain initial information from a customer through the use of a digital ratings device and to send (or allow the customer to send) that initial information to the third-party validator.

Next, at step 210, FIG. 2 shows the method 200 continues as the third-party validator gathers information about the ratable subject matter (“subject matter data”). This subject matter data can comprise any suitable information that identifies the ratable subject matter and/or its provider, or that otherwise allows the third-party validator to compare the temporal data collected with the subject matter data to determine whether the initial information was provided by a verified customer, or a customer who was actually exposed to the ratable subject matter (e.g., visited the service provider at the time of the submission of the initial information, purchased a product, etc.). Some non-limiting examples of suitable subject matter data include the location (e.g., an address, GPS coordinates, a location stamp, etc.) at which the interested party states that customers will provide initial customer feedback information; the unique digital identifier of any digital ratings devices the interested party uses to obtain initial information (e.g., a globally unique identifier, a serial number, a universally unique identifier, an O-code, etc.); the unique digital pattern contained in a survey/rating form (e.g., a form for a digital pen) used by the interested party; the IP address of the ratings device (e.g., smart phone, tablet, etc.) that the interested party uses (or allows customers to use) to upload initial information; the caller ID information from the telephone that transmits initial information from the digital ratings device to the third-party validator; the phone number of the digital device (or another device used to upload the initial information); a device identifier; the CPU ID of the computer that relays initial information from the ratings device to the validator; an estimate of a reasonable number of customers that will visit the interested party (e.g., a service provider) in any suitable specified period of time (e.g., one day); the actual number of customers that have visited the interested party in a given period of time; the interested party's business hours; the interested party's work schedule (e.g., days off, days out of the office, lunch breaks, etc.); the minimum amount of time reasonably needed between submissions of initial information; profile data; the number of products sold during a given time period; the marking (e.g., QR code, bar code, short code, etc.) associated with a product, service, survey/rating form, interested party, service provider, or other ratable subject; the location (e.g., address, GPS coordinates, city, state, region, location stamp, etc.) in which such markings are displayed; the time and date at which such markings are displayed (e.g., a time stamp or an indication of the time in which a marking is shown on television, in movie theaters, in newspapers, etc.); a facility identifier (e.g., a store identification number or business ID); a provider identification; an identifier of a point-of-sale transaction device; customer names; customer e-mail identifications; pre-screen research on one or more customers; human verification that a customer provided initial information; customer social media identifiers (e.g., the customer's username for a social media outlet); a handwriting analysis of one or more customers; and/or any other suitable information that can be compared with the temporal data to identify the customer as being a verified customer of the ratable subject matter.

While FIG. 2 shows the third-party validator collects the subject matter data before receiving initial information, the subject matter data can be supplied to the validator at any suitable time in the process. Indeed, in one non-limiting example, the subject matter data is provided during or after the initial data is collected. For instance, when the digital ratings device transmits the initial information collected from a plurality of customers during a day, the interested party may also transmit the actual number of customers that visited the interested party that day.

Returning to FIG. 2, that figure shows the method 200 continues at step 215 as the third-party validator receives initial information (e.g., as handwriting, pictures, audio, text, handwriting converted to text, and/or in any other suitable format) that was provided by customers and the temporal data associated with the initial information. In this step, the initial information and temporal data may be received in any suitable manner. In one non-limiting example, the initial information is uploaded to a server, a database, a cloud-based service, a platform as a service, an e-mail address, a fax machine, or a Web site that is controlled by the third-party validator. In some preferred embodiments, the initial information is uploaded to a server to which the validator has access.

Next, at step 220, FIG. 2 shows the method 200 continues as the third-party validator validates the initial information. In this step, the third-party validator (i.e., a software program) can validate the initial information in any suitable manner. In some non-limiting embodiments, the third-party validator validates the initial information by comparing the temporal data associated with the initial information with the subject matter data collected from the interested party (and/or customer through previous survey/rating forms provided by the customer) to ensure that the information was provided by a verified customer of the ratable subject matter. In such embodiments, the third-party validator can make any suitable comparison that allows the validator to validate or invalidate the initial information. Indeed, in one non-limiting example in which the temporal data comprises the location of the interested party's office, the third-party validator checks to see that the location information (e.g., a location stamp) sent with the initial information matches the location information gathered as part of the subject matter data. In another non-limiting example, where the temporal data comprises a unique digital identifier of a digital ratings device, a unique pattern of a survey/rating form (e.g., where the digital ratings device comprises a digital pen), a marking (e.g., a QR code, a bar code, short code, etc.), an IP address, caller ID information, a CPU ID, a phone number, a device identifier, a facility identifier (e.g., a store identification number), a business identifier, an identifier of a point-of-sale transaction device, and/or some other similar data or combination of data, the third-party validator compares that temporal data with corresponding data in the subject matter data to determine whether the initial information was provided by a verified customer.

While the validation process may be accomplished in any suitable manner, in some embodiments, initial information is only deemed verified when each and every piece of the desired temporal data is collected and found to properly coordinate with the corresponding subject matter data. In other non-limiting embodiments, however, the initial data is deemed verified when a threshold of (though not necessarily all desired) temporal data is collected and found to correspond to the collected subject matter data. For instance, where the described systems check for 10 pieces of temporal data, the systems may deem initial information to be validated when a set threshold (e.g., 7, 8, 9, or any other desired number) of pieces of the temporal data are verified.

In some non-limiting embodiments, step 225 in FIG. 2 shows the third-party validator optionally validates the initial information by checking for one or more indicators that the initial information is potentially fraudulent. In such embodiments, the indicators that initial information is potential fraudulent can include any indication that: the initial information was not provided by a verified customer; a customer submitted more initial information than requested (e.g., that multiple forms comprise similar writing (e.g., similar vectors, pressure, appearance, and/or the like, as recorded by the digital device, a computer, a human, etc.)), showing that a customer filled out more than one survey/rating form); a customer misused the digital ratings device; the initial information was not provided at an appropriate time, date, or location; and/or any other suitable indicator that the initial information was not correct and/or was not provided in good faith.

In one non-limiting example, an indication that the initial customer feedback is potentially fraudulent is that the initial information is provided by the customer outside of the interested party's business hours. Another non-limiting example of a suitable indicator of potential fraud includes an indication that the initial information was provided at a faster rate than deemed reasonable for the subject matter data. For instance, if the subject matter data indicates that the minimum time needed to complete a survey/rating form is 10 minutes and the temporal data associated with the initial information indicates that 4 survey/rating forms were completed with the same digital ratings device in 10 minutes, then the third-party validator can invalidate any or all of the survey/rating forms completed in that 10 minute period. Still another non-limiting example of a suitable indicator that the initial information is potentially fraudulent includes an indication that more customers provided initial information than reasonably expected in a set period of time. For instance, if the subject matter data states that 20 customers visited the interested party on a certain day and 25 survey/rating forms were created on that day, the third-party validator may invalidate any or all of those survey/rating forms.

Where the described systems find one or more indications of fraud, the systems can use such indications in any suitable manner. Indeed, in some non-limiting embodiments, where the described systems find one indication of fraud, the systems can invalidate all information associated with that indication. In another non-limiting embodiment, however, the systems only invalidate information when a certain pre-set threshold of fraud indicators is met.

In still other non-limiting embodiments, step 230 in FIG. 2 shows the initial information is optionally validated (or screened) by removing (e.g., deleting, leaving a blank spot, etc.) or changing (e.g., replacing offensive words with non-offensive symbols (e.g., *@%#!)) content from the initial information that meets one or more content-disqualification criteria. Some non-limiting examples of content-disqualification criteria include offensive language (e.g., swear words, epithets, vulgar language, profanity, etc.), non-professional comments (e.g., slander or ad hominem attacks that are not related to the ratable subject matter), improper use of the survey/rating form, improper data accuracy, content that violates the terms of an applicable terms of use, and/or other content that does not provide feedback that is valuable to potential customers of that ratable subject.

While some embodiments of the validation process can involve screening for content-disqualification criteria with a software application, in other embodiments, the described method 200 involves manually (e.g., via the third-party validator) screening for content-disqualification criteria. In still other embodiments, however, the method involves manually and electronically screening for content-disqualification criteria. For instance, where a software application is used to screen for standardized content-disqualification criteria (e.g., where multiple bubbles are filled in on a single question), manual screening may be used to find content-disqualification criteria that are included in the customer's written statements.

In some embodiments in which the initial information is optionally validated (or screened) by removing or changing content that meets one or more content-disqualification criteria, the initial party and/or validator is otherwise unable to manipulate the initial information. Accordingly, while the screening process may be able to remove content that meets a content-disqualification criterion, the screening process may not be manipulated to remove negative feedback or reviews—especially when it is the customer and not the interested party that uploads the initial information. Thus, the described systems and methods can remove offensive or inappropriate content, while still providing an accurate and representative review of the ratable subject matter.

Once the initial information has been validated, the validated information can be marked as being validated in any suitable manner. In one non-limiting example, the third-party validator places a stamp or seal of approval on the validated information to show that the validator has determined the validated information to have been provided by actual customers of the ratable subject matter.

As in the method 100 illustrated in FIG. 1, the method 200 in FIG. 2 can be repeated any suitable number of times. Accordingly, the third-party can provide its information validation services to any suitable number of interested parties, from any suitable field of service (i.e., the healthcare profession), and regarding any suitable ratable subject matter (i.e., services, products, facilities, etc.).

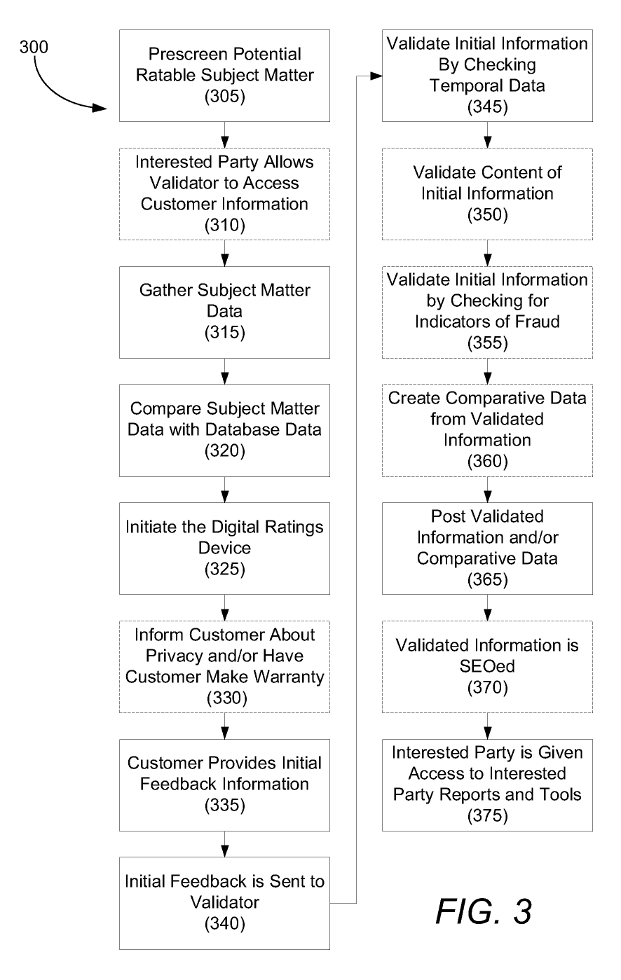

The systems and methods described herein may be modified in any suitable manner that allows them to function as intended. In this regard, some embodiments of the described systems and methods include gathering initial information, screening the information for inappropriate content, validating the initial content to ensure it was provided by actual customers of the ratable subject matter, marking the validated information as such, and publicizing the validated information. By way of non-limiting example, FIG. 3 illustrates a flowchart depicting one non-limiting embodiment of such a method 300. Again, as in the methods 100 and 200 described above, the following method 300 can be modified in any suitable manner, including, but not limited, by adding, removing, changing, and/or rearranging one or more steps in the method 300. Similarly, the following method 300 can be modified by changing the actor or actors who perform one or more steps in the method.

With respect to FIG. 3, that figure shows the method 300 begins at step 305 where the third-party validator (i.e., someone working on the validator's behalf) or any other suitable party prescreens one or more ratable subjects that could potentially be a subject in the third-party validator's information validation services. In this step, the third-party validator can pre-screen the potential ratable subject matter for virtually any desired characteristic. Nevertheless, in some non-limiting embodiments, the validator prescreens the potential ratable subject for one or more rating-disqualification criteria. In this regard, the rating-disqualification criteria can include any suitable criteria that tend to indicate that a ratable subject is substandard. Indeed, where the ratable subject matter relates to a service provider, some non-limiting examples of rating-disqualification criteria include indications that the service provider: is or has been sanctioned (e.g., for substance abuse, unprofessional conduct, negligence, controlled substance violations, negligence, fraud, sexual misconduct, failure to maintain adequate records, etc.), has a history of receiving professional disciplinary action, is a defendant in a pending malpractice suit, has lost a malpractice suit, has a serious criminal record, is not licensed, and/or has any other indication that the service provider's service is substandard. Similarly, where the ratable subject matter relates to a product, some non-limiting examples of rating-disqualification criteria include indications that the product: is dangerous, is or has been the subject of a product liability lawsuit, does not comply with conventional safety standards (e.g., lead levels, etc.), or any other indication that the product is substandard.

In some cases, because the current systems and methods can provide a relatively fair representation of a ratable subject, a substandard ratable subject (e.g., a service provider) or an interested party that knows that the ratable subject is substandard may screen itself and thereby avoid the described systems and methods. As a result, in some embodiments, the described systems and methods may be used regularly for standard or above-standard ratable subjects.

Where the third-party validator determines that a particular ratable subject meets one or more rating-disqualification criteria (e.g., violates an applicable terms of use agreement, etc.), the validator can optionally take any suitable action, including, but not limited to, preventing that ratable subject from being the subject of verified information received through the validator's information validation services. In such instances, where the ratable subject matter comprises a person or entity (e.g., a service provider), that person or entity may be able to participate as a customer to provide initial customer feedback information for some other ratable subject matter, while not being able to have its own customers provide initial information to the validator. In this manner, the third-party validator can ensure that it does not provide its information validation services to ratable subject matters that already have a bad reputation or substandard practices.

Returning to FIG. 3, step 310 shows that after the third-party validator finds that a potential ratable subject matter does not meet any rating-disqualification criteria, the interested party optionally agrees to provide the third-party validator with the ability to monitor, post, edit, modify, and/or otherwise use the initial information provided by customers of the ratable subject matter. In some embodiments, the interested party also grants the third-party validator with the right to prevent the interested party from receiving additional information validation services and/or to remove or destroy previously validated information when that interested party continually receives an average rating below a specified level.

Moving on to step 315, that step shows the illustrated method 300 continues as the third-party validator (or another suitable actor) gathers subject matter data from or about the interested party. This step can be accomplished in any suitable manner, including, without limitation, in the manner described above with respect to step 210 in FIG. 2.

Step 320 shows that the method 300 continues as the third-party validator (or another suitable actor) compares the subject matter data received from the interested party with information regarding the ratable subject matter that is provided through one or more subject matter databases. At this step, the third-party validator can update data in the databases to provide more current information about the ratable subject matter.

Continuing with the method 300, step 325 shows that any suitable actor, such as the third-party validator, the customer, or the interested party, initiates the digital ratings device. In this step, the digital ratings device may be initiated in any suitable manner that allows the device to relay initial information from the ratable subject matter's customers to the third-party validator in a manner that allows the validator to validate the initial information. In one non-limiting example, the third-party validator provides markings (e.g., QR codes, short codes, text numbers, etc.) that allow customers to use a digital device (e.g., their own device) to access a survey/ratings form. In another example, the third-party validator assigns a unique digital identifier to one or more digital ratings devices and/or provides a unique digital pattern to the ratable subject's survey/rating forms. In this example, the third-party validator can match any suitable portion of the subject matter data with the unique digital identifier and/or the unique digital pattern. For instance, the third-party validator can link the unique digital identifier to the interested party's license number, office location, and/or any other suitable subject matter data that identifies the interested party and/or the ratable subject matter. In another non-limiting example, the third-party validator initiates the digital ratings device by accessing one or more of the interested party's computers and installing software that is needed to operate the ratings device. In still another non-limiting example, the third-party validator tests the digital ratings device, obtains additional subject matter data (e.g., CPU ID, IP addresses, etc.), or otherwise prepares the ratings device to transmit initial information to the validator. In yet another non-limiting example, the third-party validator initiates the digital ratings device by posting or otherwise providing markings (e.g., QR codes, bar codes, etc.) that are configured to direct the digital ratings device (e.g., a smart phone) to a Web site containing a survey/rating form for the ratable subject matter.

According to some embodiments, step 330 shows that before or as the customer provides the initial information, the customer is optionally informed as to his or her privacy rights in the initial information. In such embodiments, the customer can be informed of his or her privacy rights in the initial information in any suitable manner. In one non-limiting example, the survey/ratings form comprises a link to an online privacy policy. In this example, the customer can be informed that any or all of the customer's initial information can be published (e.g., on the Internet).

Returning to FIG. 3, step 330 also shows that, in some embodiments, the method 300 optionally involves having the customer provide one or more warranties. While the customer can provide any warranty (e.g., by agreeing to an agreement associated with a survey/rating form or any other suitable manner), in some instances, the customer warrants that he or she is an actual customer of the ratable subject matter.

Continuing with FIG. 3, step 335 shows the interested party can instruct customers (e.g., via signage, a display comprising a marking, etc.) to use the digital ratings device to provide initial information regarding the interested party. While the interested party can perform this function in any suitable manner, in some embodiments, the interested party performs this function in the manner discussed above with respect to step 105 in FIG. 1.

After the customer provides the initial information, step 340 shows the initial information is uploaded (e.g., as images of handwriting, digital information, text, recordings, and/or in any other suitable format) to the third-party validator. Then, with the initial information uploaded, steps 345, 350, and 355 show the third-party validator can validate the initial information (e.g., to ensure the customer was actually at the premises of the interested party (e.g., service provider) when the initial information was provided, and/or to otherwise ensure the initial information was provided by an actual customer of the service provider). While this validation process can occur in any suitable manner, steps 345, 350, and 355 respectively show the information can be validated by comparing the temporal data with the subject matter data, by checking the initial information for one or more content-disqualification criteria, and/or by checking for one or more indicators of possible fraud; each of which are discussed above with respect to step 220 through 230 in FIG. 2.

After the initial information is validated as coming from a verified customer (and optionally marked as such); as being free from content-disqualification criteria; as being free from indicators of potential fraud; and/or is otherwise validated, step 360 shows that, in some non-limiting embodiments, the method 300 continues as the third-party validator compares the validated information from one ratable subject (e.g., a service provider or product) with the validated information collected from one or more other ratable subjects. In this manner, the third-party validator is able to create comparative data between ratable subjects in any suitable manner. In such embodiments, the third-party validator (or someone or a device that receives the validated information from the third-party validator) can compare the validated information from multiple ratable subjects in any suitable manner, including, without limitation, by comparing ratable subjects in the same or similar fields or class of goods, by comparing and/or contrasting ratable subjects in a geographical location (e.g., zip code, city, state, country, etc.), and/or in any other suitable manner. This comparative data can then be used by potential customers to compare ratable subjects and to make an informed decision as to which ratable subject will likely meet the potential customer's particular needs and desires. By way of non-limiting example, where the described systems compare the validated information from a variety of service providers, potential customers can look at the comparison to see which provider has the highest ratings or how a particular provider compares with his or her colleagues.

Step 365 shows the method 300 can continue as the third-party validator (or another suitable party) posts the validated information (which may include comparative data). In this step, the validated information may be posted in any suitable manner. In one non-limiting example, the validated information is posted in an electronic format, including, but not limited to, being posted on the Internet, in one or more e-mail communications, and/or in any other suitable electronic form. In another non-limiting embodiment, the validated information is placed in a physical format, including, but not limited to, being placed in a magazine, a newspaper, a book, and/or in any other suitable physical form.

In some presently preferred embodiments, the validated information is posted on the Internet. In such embodiments, the validated information can be posted in any suitable manner. In one non-limiting example, the validated information is automatically posted on a Web site controlled or otherwise designated by the interested party, the third-party validator, a rating/survey aggregator (e.g., the TERILLION® Global Directory, City Search, Dex Knows, ProCompare, Epinions, Google Reviews, Trip Advisor, etc.); on one or more online directories; an online ratings publisher; and/or any other suitable person or organization's Web site. In another non-limiting example, the validated information is posted on a Web site that is controlled or otherwise selected by the interested party (e.g., a service provider). In still another non-limiting example, the validated information is automatically posted on a plurality of Web sites. In any case, when the validated information is posted on the Internet, the validated information can be posted in any suitable manner, including, without limitation, by being placed in a Web widget, in a ratings widget, in RSS feeds, in meta tags, in buttons, in icons, in social media icons, and/or in any other suitable manner that allows it to be viewed or accessed.

While the validated information can be posted in any suitable manner (including, without limitation, as text, handwriting, symbols, colors, graphs, etc.), in some embodiments, the posting of validated information includes displaying information (e.g., validated information) as handwriting (e.g., images of handwriting obtained from a camera, handwriting obtained from a digital pen, touch screen device, signature/writing capture device, etc.). While posting at least a portion of the validated information in handwriting may serve many purposes, in some embodiments, it allows those viewing the information to see that the validated information was provided by real people, and in some instances, by multiple people (as would be reflected in the different appearances of the handwriting). In some embodiments, in addition to posting customer handwriting as part of the validated information, the validated information optionally includes printed text that is transcribed from the handwriting).

Where the validated information is posted on the Internet, step 370 shows the validated information or related one or more related Web sites are optionally search engine optimized (“SEOed”) to help Web pages including the validated information to be given higher rankings in typical search engine search results. While this process of being SEOed can be accomplished in any suitable manner, in some non-limiting embodiments, as the validated information is posted on one or more Internet sites (e.g., on one or more online directories, on the third-party validator's site, on ratings forums, on the interested party's site, etc.), such validated information may include (i.e., automatically) a link to virtually any other site or sites. Indeed, in some embodiments, when the validated information is posted online, the validated information includes a link back to the interested party's (e.g., a service provider's) Web site, the third-party validator's Web site, and/or any other suitable site. Because many search engines rank sites based on the number of links going to the sites, such embodiments may greatly help to improve the ranking of Web sites that are linked to verified information. In this manner, the validated information can help the related ratable subject matter be moved higher in relevant search engine results. Accordingly, the validated information can further increase the “visibility” of the ratable subject matter on the Internet.

Step 375 shows the method 300 continues as the third-party validator (or any other suitable actor displaying the validated information) provides the interested party (e.g., a service provider) with access to interested party reports and tools. While the interested party can be allowed to access any suitable type of reports, some examples of suitable reports include, but are not limited to, ongoing reports showing initial information in near real-time, reports displaying comparative information in near real-time, reports showing specific search engine ratings for Web pages containing the validated information, reports of possible ways to mitigate risks, reports of possible ways to improve the ratable subject (e.g., services), and/or any other suitable report. Similarly, some non-limiting examples of suitable tools include, search engine optimization tools, linking tools, analytic tools, reporting tools, ranking tools, display tools, SEO tools, and any other suitable tool that allows an interested party to use the initial or validated information. In light of the foregoing, it should be noted that in some embodiments, the interested party has no ability to delete, remove, revise, or otherwise edit initial information or validated information (except, in some non-limiting cases, to bring such information into compliance with the corresponding terms of use (as discussed above) (e.g., to replace swear words with symbols, such as “#%!&$”)).

As in the methods described above, the method 300 shown in FIG. 3 can be repeated any suitable number of times to allow one or more interested parties to obtain, and to allow the third-party validator to provide, validated information about the ratable subject matter.

In addition to the aforementioned modifications, the described systems and methods can be changed in any other suitable manner. In one non-limiting example, the described methods automatically post validated information or allow the customer to post validated information he or she provided on a social network (e.g., Facebook, twitter, Linked In, MySpace, etc.). In this manner, the described methods can allow validated information on a ratable subject to be quickly disseminated.

Where the described methods allow the customer to post information (e.g., validated information) on one or more social networks, the customer can post the information in any suitable manner. Indeed, in one non-limiting example, after the customer has provided the initial information, the customer is able to easily post the information to a social network (e.g., by selecting a social network option that posts the information to an account of the interested party, the validator, or another party; or by logging into the customer's social network account). In another non-limiting example, before being allowed to provide initial information through the digital ratings device, the customer can log into (or otherwise provide the username and password to) a social network account. In some cases, where the customer logs into the customer's account, the third-party validator (or another actor) can obtain additional demographic data about the customer from the customer's social network profile. Accordingly, by associating such demographic data with the corresponding validated information, the validator can gather and/or provide additional information about the ratable subject (e.g., what demographics provide initial information, what demographics approve or disapprove of the ratable subject matter, what demographics typically pay for the ratable subject matter, additional subject matter data, etc.)

In another non-limiting example of how the described methods can be changed, in addition to (or in place of) marking validated information as such, some embodiments of the described systems and methods provide a reliability index for the validated information that is obtained from a customer's initial information (e.g., completed survey/ratings form). Although this reliability index can be provided in any suitable manner, in some non-limiting embodiments, it is obtained by comparing one or more pieces of temporal data with subject matter data, and then lowering the reliability index for the corresponding verified data by some amount for each portion the desired temporal data that is not obtained or that is not correct.

By way of non-limiting example, where the described systems and methods check for 20 pieces of temporal data, and the 20 pieces are all present and correct when compared against the corresponding subject matter data, the corresponding validated information may have the highest reliability index available (e.g., a 100% reliability index, a 95% reliability index (where it assumed that 95% is the highest achievable score), a 5 out of 5, etc.). In another example, for each piece of temporal data that is missing (or not completely correct when compared with the appropriate subject matter data), the reliability index can drop. For instance, where 19 of 20 desired pieces of temporal data are obtained and determined to be correct (or to fall within a suitable range), the corresponding validated may have the second highest score possible (e.g., a 95%, a 90% (where 95% is determined to be the highest possible score), a 4 out of 5, etc.). In still another non-limiting example, when the customer's initial information fails to meet a threshold number of pieces of correct temporal data, such information is invalidated or barred from being marked as validated or from receiving a reliability index.

Where the described systems and methods provide a reliability index for validated information, the systems and methods can check for any suitable number of pieces of temporal data, including, 1, 2, 3, 4, 5, 6, 7, 8, 9, 10, or more. Indeed, in some non-limiting examples, the described systems check for between about 10 and about 60 pieces of temporal data (e.g., about 20±5).

Although in some embodiments, each piece of temporal data carries the same weight when determining a reliability index, in other non-limiting embodiments, some pieces of temporal data weighted more heavily than others. In such embodiments, the various pieces of temporal data can be weighted in any suitable manner that helps the reliability index accurately reflect the reliability of corresponding validated information.

Additionally, when determining a reliability index, some embodiments of the described systems and methods include checking for indications that information is potentially fraudulent. In some such embodiments, when such an indication is found, the initial information may be barred from being marked as validated or receiving a reliability index. In other non-limiting embodiments, however, when the described systems detect one or more indications of fraud, the systems drop the corresponding reliability index by a certain amount (e.g., by 5%, 1 point, 1 star, or any other suitable amount).

In a further non-limiting example of how the described methods can be changed, the methods optionally include providing the customer with an instant reward upon the provision of the initial information and/or posting validated information to a social network. While the instant reward can be provided to the customer in any suitable manner, in some embodiments, the instant reward is provided as a promo code, a key word, a QR code, an e-mail or text sent to the interested party, or some other message that can be relayed to a party (e.g., the interested party) in order to allow the customer to receive a reward (e.g., a discount, a free item, etc.). Indeed, in some embodiments, the instant reward (e.g., promo code, etc.) is provided through (e.g., on the screen of) the digital ratings device (e.g., the customer's smart phone, tablet, etc.). In this manner, the customer may be motivated to provide initial information and/or to have the corresponding validated information posted on a social network. For instance, where a customer sees a QR code in a check-out line, the customer can use the digital ratings device (e.g., a smart phone) to scan the code and complete a survey/rating form before purchasing an item. In such instances, the customer can take the instant reward message to a check-out stand in order to receive a discount when purchasing the ratable subject or another item.

In another non-limiting example of how the described methods can be changed, instead of providing a reward directly to a customer for providing initial information (as discussed above), in some embodiments, a donation is given to a charitable organization or cause (e.g., the Red Cross, United Way, etc.) as the described validation services are used. In this regard, the donation to the charitable cause can be made in any suitable manner, including, without limitation, by providing a set donation to a charitable cause for each survey/ratings form that is completed, giving a donation to a charitable cause based on the amount of subscription time or service level that the interested party agrees to, etc. For instance, as the customer is instructed to provide initial information (e.g., via signage with a marking, etc.), the customer may be informed that a donation is made to a charitable organization for each survey/rating form that is completed. Thus, while some customers may be swayed to provide an unduly favorable review when such customers receive a direct reward, some customers may be more likely to provide a fair and representative review when such customers are only receiving some indirect reward (such as knowing that the customers' initial information helped send a donation to a good cause).

Where the described systems and methods are used to provide a donation to a charitable cause, the donation can be provided by any suitable party (“sponsor”). In one non-limiting example, the interested party, the third-party validator, and/or a third party makes a donation to the charitable cause. In still another non-limiting example, one party (e.g., a third party) can provide the donation on behalf of another party (e.g., the interested party).

In some embodiments in which the described systems and methods allow a sponsor to provide a donation to a good cause in connection with the systems use, the described systems and methods provide credit to such sponsors. In this manner, the sponsors can build goodwill in their name and further incentivize customers to provide initial information. While this credit can be provided to the sponsor, in one non-limiting example, before, during, or after the customer provides initial information, the survey/ratings form (or the digital device) provides the customer with a link to the sponsor's Web site, or with a statement saying something to the effect of “Because of your review MEGA CORP. has made a donation to a local food bank.”

In still another non-limiting example, the described systems and methods can be modified to generate money in any suitable manner. Indeed, in some implementations, the interested party pays the validator a blanket license for providing the validation services. In other implementations, the interested party pays the validator a fee for each customer that provides initial information. In still other implementations, the survey/rating forms comprise or are otherwise associated with advertisements that generate revenue (e.g., via charging for real estate on the form, via a cost-per-click method, via a cost-per-conversion method, lead generation, etc.). In yet other implementations, the interested party receives the described validation services through a subscription plan. In this regard, the subscription plan can be for any suitable length of time (e.g., a monthly, quarterly, yearly, etc. subscription plan) and/or number of validations (i.e., an unlimited plan; a tiered pricing plan, based on the number of validations; etc.). In still other implementations, the described verification services are provided as a platform as a service offering (e.g., as a subscription) through a cloud-based computer system.

In even a further non-limiting example of the manner in which the described systems and methods can be changed, in some embodiments, the systems and methods optionally allow customers to provide initial information without going through the described verification process. By way of non-limiting example, in addition to (or in place of) providing information through the described survey/ratings form, some embodiments provide customers with an ability to use a non-validated ratings program (e.g., GOOGLE PLACES).

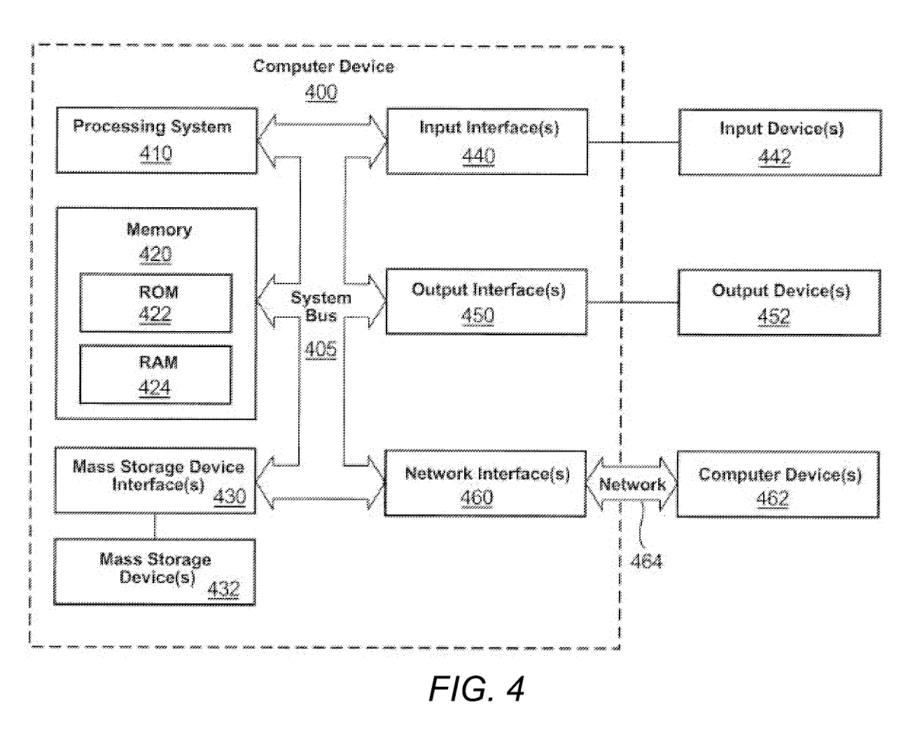

The described systems and methods can be used with or in any suitable operating environment and/or software. In this regard, FIG. 4 and the corresponding discussion are intended to provide a general description of a suitable operating environment in accordance with some embodiments of the described systems and methods. As will be further discussed below, some embodiments embrace the use of one or more processing (including, without limitation, micro-processing) units in a variety of customizable enterprise configurations, including in a networked configuration, which may also include any suitable cloud-based service, such as a platform as a service or software as a service.

Some embodiments of the described systems and methods embrace one or more computer readable media, wherein each medium may be configured to include or includes thereon data or computer executable instructions for manipulating data. The computer executable instructions include data structures, objects, programs, routines, or other program modules that may be accessed by one or more processors, such as one associated with a general-purpose processing unit capable of performing various different functions or one associated with a special-purpose processing unit capable of performing a limited number of functions.

Computer executable instructions cause the one or more processors of the enterprise to perform a particular function or group of functions and are examples of program code means for implementing steps for methods of processing. Furthermore, a particular sequence of the executable instructions provides an example of corresponding acts that may be used to implement such steps.

Examples of computer readable media (including non-transitory computer readable media) include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing unit.

With reference to FIG. 4, a representative system includes computer device 400 (e.g., a digital ratings device or other unit), which may be a general-purpose or special-purpose computer. For example, computer device 400 may be a personal computer, a notebook computer, a PDA or other hand-held device, a workstation, a digital pen, a digital ratings device, a digital ratings device dock, a digital ratings device controller, a minicomputer, a mainframe, a supercomputer, a multi-processor system, a network computer, a processor-based consumer device, a cellular phone, a tablet computer, a smart phone, a feature phone, a smart appliance or device, a control system, or the like.

Computer device 400 includes system bus 405, which may be configured to connect various components thereof and enables data to be exchanged between two or more components. System bus 405 may include one of a variety of bus structures including a memory bus or memory controller, a peripheral bus, or a local bus that uses any of a variety of bus architectures. Typical components connected by system bus 405 include processing system 410 and memory 420. Other components may include one or more mass storage device interfaces 430, input interfaces 440, output interfaces 450, and/or network interfaces 460, each of which will be discussed below.

Processing system 410 includes one or more processors, such as a central processor and optionally one or more other processors designed to perform a particular function or task. It is typically processing system 410 that executes the instructions provided on computer readable media, such as on the memory 420, a magnetic hard disk, a removable magnetic disk, a magnetic cassette, an optical disk, or from a communication connection, which may also be viewed as a computer readable medium.

Memory 420 includes one or more computer readable media (including, without limitation, non-transitory computer readable media) that may be configured to include or includes thereon data or instructions for manipulating data, and may be accessed by processing system 410 through system bus 405. Memory 420 may include, for example, ROM 422, used to permanently store information, and/or RAM 424, used to temporarily store information. ROM 422 may include a basic input/output system (“BIOS”) having one or more routines that are used to establish communication, such as during start-up of computer device 400. RAM 424 may include one or more program modules, such as one or more operating systems, application programs, and/or program data.

One or more mass storage device interfaces 430 may be used to connect one or more mass storage devices 432 to the system bus 405. The mass storage devices 432 may be incorporated into or may be peripheral to the computer device 400 and allow the computer device 400 to retain large amounts of data. Optionally, one or more of the mass storage devices 432 may be removable from computer device 400. Examples of mass storage devices include hard disk drives, magnetic disk drives, tape drives, solid state mass storage, and optical disk drives.

Examples of solid state mass storage include flash cards and memory sticks. A mass storage device 432 may read from and/or write to a magnetic hard disk, a removable magnetic disk, a magnetic cassette, an optical disk, or another computer readable medium. Mass storage devices 432 and their corresponding computer readable media provide nonvolatile storage of data and/or executable instructions that may include one or more program modules, such as an operating system, one or more application programs, other program modules, or program data. Such executable instructions are examples of program code means for implementing steps for methods disclosed herein.

One or more input interfaces 440 may be employed to enable a user to enter data (e.g., initial information) and/or instructions to computer device 400 through one or more corresponding input devices 442. Examples of such input devices include a keyboard and/or alternate input devices, such as a digital camera, a sensor, bar code scanner, debit/credit card reader, signature and/or writing capture device, pin pad, touch screen, mouse, trackball, light pen, stylus, or other pointing device, a microphone, a joystick, a game pad, a scanner, a camcorder, and/or other input devices. Similarly, examples of input interfaces 440 that may be used to connect the input devices 442 to the system bus 405 include a serial port, a parallel port, a game port, a universal serial bus (“USB”), a firewire (IEEE 1394), a wireless receiver, a video adapter, an audio adapter, a parallel port, a wireless transmitter, or another interface.

One or more output interfaces 450 may be employed to connect one or more corresponding output devices 452 to system bus 405. Examples of output devices include a monitor or display screen, a speaker, a wireless transmitter, a printer, and the like. A particular output device 452 may be integrated with or peripheral to computer device 400. Examples of output interfaces include a video adapter, an audio adapter, a parallel port, and the like.

One or more network interfaces 460 enable computer device 400 to exchange information with one or more local or remote computer devices, illustrated as computer devices 462, via a network 464 that may include one or more hardwired and/or wireless links. Examples of the network interfaces include a network adapter for connection to a local area network (“LAN”) or a modem, a wireless link, or another adapter for connection to a wide area network (“WAN”), such as the Internet. The network interface 460 may be incorporated with or be peripheral to computer device 400.

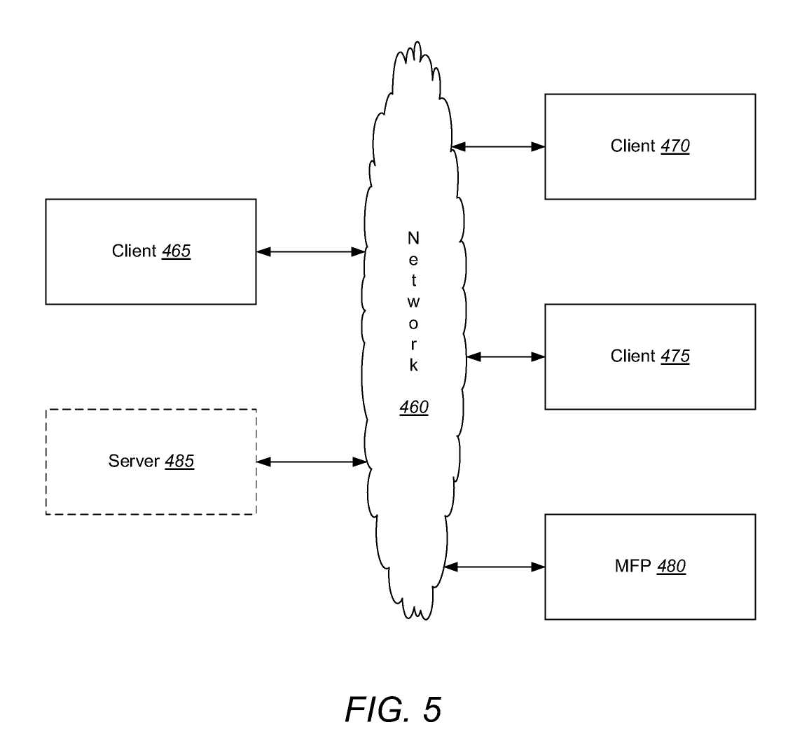

In a networked system, accessible program modules or portions thereof may be stored in a remote memory storage device. Furthermore, in a networked system computer device 400 may participate in a distributed computing environment, where functions or tasks are performed by a plurality networked computer devices. While those skilled in the art will appreciate that the described systems and methods may be practiced in networked computing environments with many types of computer system configurations, FIG. 5 represents an embodiment of a portion of the described systems in a networked environment that includes clients (465, 470, 475, etc.) connected to a server 485 via a network 460. While FIG. 5 illustrates an embodiment that includes 3 clients (e.g., digital ratings devices, etc.) connected to the network, alternative embodiments include at least one client connected to a network or many clients connected to a network. Moreover, embodiments in accordance with the described systems and methods also include a multitude of clients throughout the world connected to a network, where the network is a wide area network, such as the Internet. Accordingly, in some embodiments, the described systems and methods can allow many interested parties (e.g., service providers), customers, third-party validators, etc. to help generate validated information from many places throughout the world. Additionally, as shown in FIG. 5, in some non-limiting embodiments, the interested party uses the described methods through a cloud-based computing system (e.g., a platform as a service or a software as a service technique).

The described systems and methods may have several beneficial characteristics. In one non-limiting example, because the described systems and methods are capable of determining whether initial information was provided by verified customers of the ratable subject, the described systems and methods may prevent or reduce competitors' ability to post disparaging remarks about the ratable subject.

In another non-limiting example, because some embodiments of the described system require customers to provide initial information at a certain time (e.g., before leaving an establishment, before receiving an instant reward, when or shortly after a marking (e.g., a QR code or short code) is shown on TV or on a movie screen, etc.) and/or in a certain place, such embodiments can help the validated information be posted shortly after the customer is exposed (e.g., purchases or receives) the ratable subject matter.

In another non-limiting example, because some embodiments of the described methods allow the customer to upload the initial information in a substantially private manner (e.g., via the customer's own digital ratings device), such embodiments may be used to provide blind surveys, wherein the interested party is unaware of which customer provided which information. As a result, the customers may feel more comfortable in giving honest opinions than they may otherwise be.

In another non-limiting example, because the described systems and methods can be used to screen for indications that a set of initial information is potentially fraudulent, some embodiments of the described systems and methods can make sure that each customer is only able to provide initial information about the ratable subject once during a visit to that subject (e.g., where the ratable subject is a service provider) or after the purchase of that subject (e.g., where the ratable subject is a product). Accordingly, unlike some conventional ratings methods that allow a single user to skew a ratable subject matter's ratings by posting multiple reviews of that ratable subject, the current methods work to provide a more complete picture of the ratable subject matter.

In still another non-limiting example, because the described systems and methods can easily be used by all or most of the customers that are exposed to a ratable subject matter, the described systems and methods may provide a more fair and reliable representation of what the ratable subject's customers think of the subject than may certain conventional online ratings systems in which customers generally only post their feedback on the ratable subject matter when they have an incentive (e.g., to hurt the service provider).

In still another non-limiting example, because the described systems and methods associate temporal data with a customer's initial information, the initial information can be validated as coming from a verified customer without disclosing that customer's identity.

In still another example, in some instances, the customer is able to initiate the provision of initial information (e.g., by scanning a QR code, bar code, or other marking; sending a text; etc.) as opposed to receiving a phone call or being directly asked to provide such information. Additionally, in some embodiments, the customers do not need to speak with a person (e.g., an interested party), or to use a phone call to provide initial information.

In yet another non-limiting example, the described systems and methods allow customers to generate relatively large amounts of content related to a particular ratable subject matter. As this content is posted to the Internet, viewed by others, and SEOed, the search engine ratings for pages containing validated information relating to that subject matter can be increased. As a result, the ratable subjects with the highest rankings tend to be moved to the top of the search engine search results, while ratable subjects with lower rankings tend to be moved down in the search results.

In sum, the described systems and methods may provide validated information that depicts a fair and reliable representation of the ratable subject matter, as determined by the ratable subject's verified customers. As a result, the described systems and methods can be more useful to the interested party as well as to potential customers than may some conventional Internet ratings systems.

While specific embodiments and examples of the present invention have been illustrated and described, numerous modifications come to mind without significantly departing from the spirit of the invention, and the scope of protection is only limited by the scope of the accompanying claims.

1. A method for an interested party to obtain validated customer feedback information about a ratable subject matter, the method comprising:
instructing a customer to provide initial customer feedback information about the ratable subject matter;
using a digital ratings device to collect the initial information and to associate temporal data with the initial information; and
uploading the initial information to a third-party validator, wherein the third-party validator validates the initial information to obtain the validated customer feedback information by checking the temporal data to ensure the customer is a verified customer of the ratable subject matter.

2. The method of claim 1, wherein the ratable subject matter comprises a product, and wherein the temporal data comprises a marking that is accessible only after the product or its packaging is opened or purchased.

3. The method of claim 2, wherein the marking comprises a unique quick response code.

4. The method of claim 1, wherein the digital ratings device comprises an electronic device selected from a digital pen, a smart phone, a tablet computer, a personal digital assistant, a handheld computer, a laptop computer, a point-of-sale transaction device, a scanner, a camera, and a fax machine.

5. The method of claim 1, wherein the step of instructing the customer to provide initial information comprises presenting a marking to the customer, wherein the marking guides the customer to a form for entering the initial information about the ratable subject matter.

6. The method of claim 1, wherein the customer is required to sign into a social media account before the initial information is released to the third-party validator.

7. The method of claim 1, wherein the third-party validator further compares the temporal data associated with the initial customer feedback information against subject matter data to provide corresponding validated customer feedback information with a reliability index.

8. The method of claim 1, wherein the customer provides the initial information on paper and an image of that paper with the initial information is then uploaded to the third-party validator.

9. The method of claim 1, wherein the third-party validator further validates the initial information by checking the initial information for an indicator that the initial information is potentially fraudulent.

10. A method for a third-party validator to provide validated customer feedback information about a ratable subject matter, the method comprising:
receiving initial customer feedback information regarding the ratable subject matter, wherein the initial information was provided by a customer, and wherein the initial information was gathered by a digital ratings device that records the initial information and associates the initial information with temporal data regarding the conditions under which the initial information was provided; and
validating the initial information to provide the validated customer feedback information by checking the temporal data to ensure the customer is a verified customer of the ratable subject matter.

11. The method of claim 10, wherein the ratable subject matter comprises a product, and wherein the temporal data comprises a marking that is accessible only after the product or its packaging is opened or purchased.

12. The method of claim 10, wherein the step of validating of the initial information further comprises checking the initial information for an indicator that the initial information is potentially fraudulent.

13. The method of claim 12, wherein the indicator is selected from an indication that the initial information was provided outside business hours of the interested party, an indication that the initial information was provided at a faster rate than specified as being reasonable, an indication that more customers provided the initial information than specified as being reasonable in set period of time, and an indication that the customer provided the initial information multiple times.

14. The method of claim 10, wherein the third-party validator further compares the temporal data associated with the initial customer feedback information against subject matter data to provide corresponding validated customer feedback information with a reliability index.

15. A method for an interested party to obtain validated customer feedback information about a ratable subject matter that is associated with the interested party, the method comprising:
instructing a customer to use a digital ratings device to collect initial customer feedback information about the ratable subject matter;
using the digital ratings device to collect the initial information, to gather temporal data relating to the conditions in which the customer provides the initial information, and to associate the temporal data with the initial information;
sending the initial information to a third-party validator, wherein the third-party validator validates the initial information to obtain the validated customer feedback information by: (i) checking the temporal data to ensure the customer is a verified customer of the ratable subject matter and (ii) checking the initial information for an indicator that the initial information is potentially fraudulent.

16. The method of claim 15, wherein the digital ratings device comprises an electronic device selected from a digital pen, a smart phone, a tablet computer, a personal digital assistant, a handheld computer, and a point-of-sale transaction device.

17. The method of claim 15, wherein the step of instructing the customer to provide the initial information comprises presenting a quick response code to the customer, wherein the code is configured to cause a Web site to open on the digital ratings device when an image of the code is captured by the digital ratings device, and wherein the Web site provides the customer with a form for entering the initial information about the ratable subject matter.

18. The method of claim 15, wherein the ratable subject matter comprises a product, and wherein the temporal data comprises a marking that is usable only after the product or its packaging is opened or purchased.

19. The method of claim 15, wherein the third-party validator further compares the temporal data associated with the initial information against subject matter data to provide corresponding validated customer feedback information with a reliability index.

20. The method of claim 15, further comprising incentivizing the customer to provide the initial information by indicating that money will be donated to a charitable cause as a result of the provision of the initial information.

21. The method of claim 15, wherein the validated customer feedback information is at least partially posted online as handwriting.
